(19) United States
(12) Patent Application Publication
(10) Pub. No.: US 2009/0235514 A1
(43) Pub. Date: Sep. 24, 2009

(54) MACHINE FOR ASSEMBLING METAL SECTION BARS OF FRAMES

(75) Inventor: Andrea Caiumi, Carpi (IT)

Correspondence Address: LAUBSCHER & LAUBSCHER, P.C., 1160 SPA ROAD, SUITE 2B, ANNAPOLIS, MD, 21403, US

(73) Assignee: EMMEGI S.P.A., Soliera, MO (IT)

(21) Appl. No.: 12/300,139

(22) PCT Filed: May 10, 2007
(86) PCT No.: PCT/IB07/01224

§ 371 Date: Mar. 12, 2009

(30) Foreign Application Priority Data
May 10, 2006 (IT) MO2006A000146

(51) Int. Cl. B23Q 39/04

(52) U.S. Cl. 29/563

(57) ABSTRACT

A machine tool for assembling metal section bars of casings includes an assembly unit arranged for supporting and assembling the metal section bars, the assembly unit being movable between a first operating position in which the metal section bars are positionable on the assembly unit and a second operating position in which the metal section bars can be subjected to a desired machining.

The invention relates to a machine tool arranged for assembling metal section bars of casings.

In particular, the invention relates to a caulking machine arranged for caulking metal section bars for making casings of frames, such as, for example, windows, french windows, doors, shutters, and the like.

The caulking machines used in the door and window industry, or corner assembling machines, are arranged for fixing the corners of the casings.

Each corner of a casing is defined by a pair of metal section bars, for example extruded aluminium sections, that are appropriately placed near one another and previously connected at respective end portions by connecting elements, or corner joints.

Each corner joint, which for example also may be an extruded aluminium section, comprises a pair of arms each provided with a fixing seat, and arranged in such a way as to make a substantially L-shaped structure.

Each arm is arranged for being inserted into a respective housing obtained in the aforesaid end portions of the section bars to be joined.

In order to fix a pair of section bars to the respective corner joint, and thus make a corner of the casing, it is necessary to deform plastically a portion of the metal section bars that is positioned near the corresponding fixing seat.

In this way, the deformed portions each engage the respective fixing seat, achieving mechanical locking between the section bars and the corner joint interposed therebetween.

Subsequently, depending on the different types of casings that it is desired to make, a glue can be injected into holes that have previously been made in the section bars, which glue is arranged for stably fixing the section bars.

Caulking machines are known that are arranged for fixing the corners of a casing, comprising a box framework closed below by a base and by a supporting plate above.

With the supporting plate there is associated a supporting element, which is substantially L-shaped, arranged for supporting, in use, a pair of section bars to be caulked, previously connected by a corner joint by an operator.

These machines further comprise a caulking head supported by the supporting plate and arranged for caulking and gluing, each time, a pair of section bars, until the desired casing is made.

In particular, the caulking head is provided with a caulking clamp, positioned near the vertex of the supporting element, comprising a pair of jaws, each supporting a metal cutter arranged for plastically deforming a respective portion of metal section bar facing the latter.

In order to make a casing using known caulking machines, it is therefore necessary for an operator to connect manually a first section bar to a second section bar by a first corner joint, position an L-shaped structure thus obtained on the supporting element, and manually drive the caulking head, which fixes the first section bar to the second section bar and makes a first corner of the casing.

Subsequently, the operator removes from the caulking machine the L-shaped structure that has just been fixed, inserts into one of the free ends of the latter a second corner joint, and associates therewith a third section bar, obtaining a U-shaped structure.

Subsequently, the operator manually positions the U-shaped structure thus obtained on the supporting element, and manually drives the caulking head that fixes the third section bar to the L-shaped structure, making a second corner of the casing.

Still subsequently, the operator removes from the caulking machine the thus fixed U-shaped structure, inserts a third and a fourth corner joint into a fourth section bar and associates the fourth section bar with the free ends of the U-shaped structure, obtaining a closed, for example rectangular, structure.

Subsequently, the operator manually positions the closed structure thereby obtained on the supporting element, and manually drives the caulking head that fixes the fourth section bar to one of the free ends of the U-shaped structure so as to make a third corner of the casing.

Still subsequently, the operator removes the partially fixed closed structure, rotates the partially fixed closed structure and repositions the partially fixed closed structure on the caulking head that fixes a fourth corner of the casing.

It should be noted that during caulking operations, the caulking forces are discharged by the caulking clamps onto the supporting plate, caulking clamps being associated with the latter by a threaded connection.

A drawback of known caulking machines consists of the low productivity thereof.

In fact, these machines enable only one corner at a time to be caulked, which corner must have been previously assembled manually by an operator.

A further drawback consists of the need to provide an operator, with a consequent increase in production costs, to perform manually the tasks of assembling and positioning on the caulking machine the section bars to be fixed.

This means that such tasks are excessively slow and laborious.

Further, the operator may commit centering errors and compromise the subsequent caulking of the section bars, or injure himself by coming into contact accidentally with the free ends of the section bars to be joined.

Also manually moving the partially assembled section bars, in particular for section bars of large dimensions, may be particularly heavy for the operator.

A still further drawback relates to the operations that are necessary for reconfiguring the aforesaid caulking machines following a change in the size of the section bars to be caulked.

In fact, these operations are particularly slow and difficult.

An object of the invention is to improve the machine tools arranged for assembling metal section bars of casings.

Another object is to improve machine tools arranged for caulking metal section bars for making casings.

A further object is to make machine tools that enable productivity to be increased with respect to known caulking machines.

A still further object is to obtain machine tools that enable the section bars to be assembled rapidly.

Still another object is to make machine tools that enable rapid and precise centering of the section bars to be assembled.

Another still further object is to make machine tools that are easily and rapidly reconfigurable following a change in the size of the section bars to be caulked.

Still another object is to obtain caulking machines provided with a device for discharging the caulking forces that is alternative to known devices.

In a first aspect of the invention, there is provided a machine tool for assembling metal section bars of casings comprising an assembly unit arranged for supporting and assembling said metal section bars and which is movable between a first operating position in which said metal section bars are positionable on said assembly unit and a second operating position in which said metal section bars can be subjected to a desired machining.

This machine tool may comprise at said first operating position and at the aforesaid second operating position respectively a first manipulating unit and a second manipulating unit, each of which is provided with an anthropomorphic robot.

In particular, the anthropomorphic robot of the first manipulating unit is arranged for loading said metal section bars on said assembly unit, whilst the anthropomorphic robot of the second manipulating unit can be provided with caulking means arranged for caulking and gluing said metal section bars, or with a drilling unit arranged for drilling said section bars, or with a broaching machine arranged for inserting broaches into said section bars, or with a screwing head.

Owing to this aspect of the invention, it is possible to make highly automated machines that enable the metal section bars to be positioned, assembled and caulked automatically. This enables the productivity of the machines to be significantly increased by reducing production time and reducing or even eliminating the need for an operator.

This further enables the machine to be reconfigured easily and quickly following a change in the size of the section bars to be assembled.

In fact, it is sufficient, depending on the size of the section bars to be assembled, on the one hand to reprogram appropriately the assembly unit, the first manipulating unit and the second manipulating unit and on the other to change, if necessary, the caulking tools.

In a second aspect of the invention, there is provided a machine tool arranged for assembling elongated elements for making casings, comprising supporting frame means arranged for supporting said elongated elements and centering means arranged for centering said elongated elements on said supporting frame means, characterised in that said centering means comprises compensating means arranged for compensating possible dimensional variations of said elongated elements. Owing to this aspect of the invention it is possible to obtain centering means that enables the section bars to be centred precisely on the supporting frame means.

In a third aspect of the invention, there is provided a machine tool arranged for caulking metal section bars for making casings, comprising supporting frame means and clamp means arranged respectively for supporting and for caulking said metal section bars, characterised in that said machine tool further comprises coupling means arranged for removably coupling said clamp means with said frame means.

In an embodiment of the invention, the coupling means comprises pin means associated with the clamp means, and seat means associated with the supporting frame means, the pin means being arranged for engaging said seat means in a removable manner.

Owing to this aspect of the invention, it is possible to make a device for discharging caulking forces that is an alternative to known devices.

In fact, the caulking forces are discharged by the pin means directly onto the supporting frame means.

The invention can be better understood and implemented with reference to the attached drawings in which an embodiment of the invention is shown by way of non-limiting example, in which:

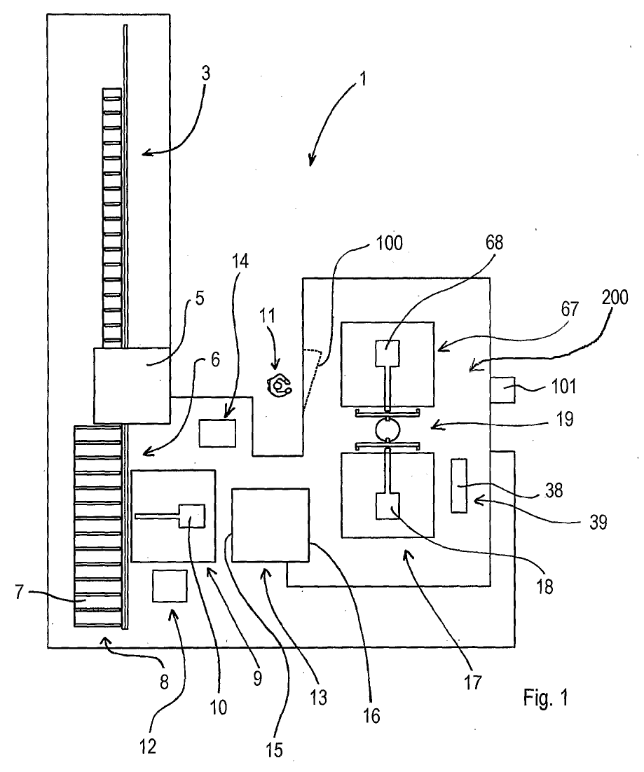

FIG. 1 is a schematic top view of a system for machining and assembling casings of frames;

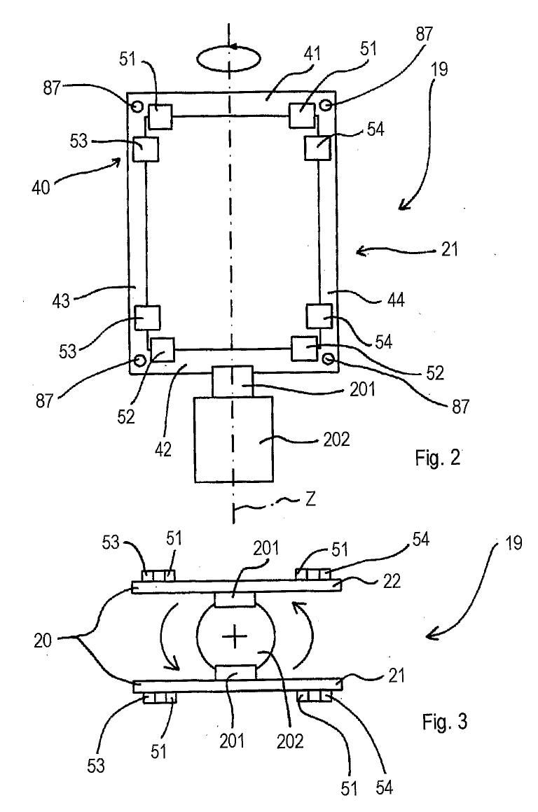

FIG. 2 is a schematic front view, with some details removed, of an assembly unit included in the system in FIG. 1;

FIG. 3 is a top view of the assembly unit in FIG. 2;

FIG. 4 is a schematic front view of a centering device included in the assembly unit in FIG. 2;

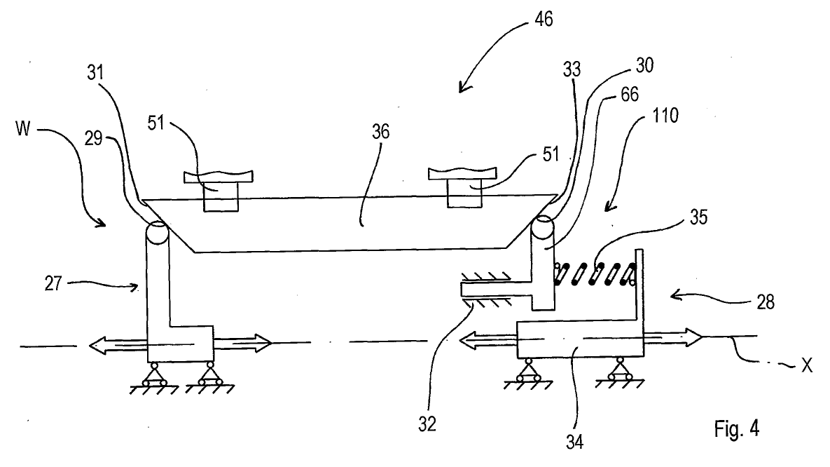

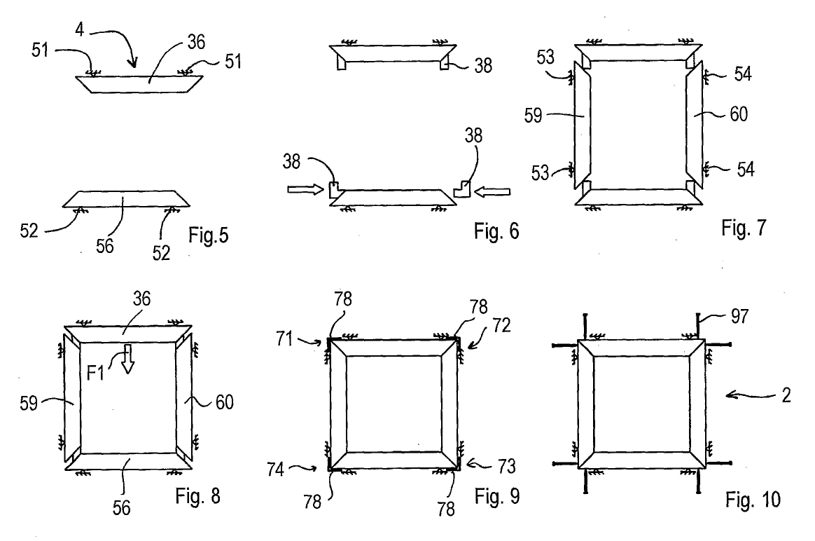

FIGS. 5 to 10 illustrate a possible operating sequence of the system in FIG. 1;

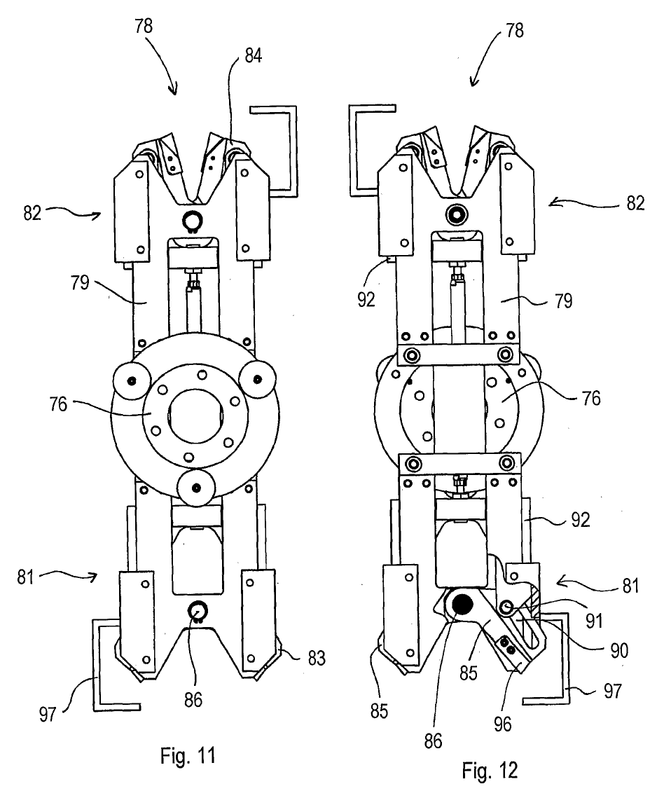

FIG. 11 is a top view of a caulking device included in the system in FIG. 1;

FIG. 12 is a partially sectioned view from below of the caulking device in FIG. 11;

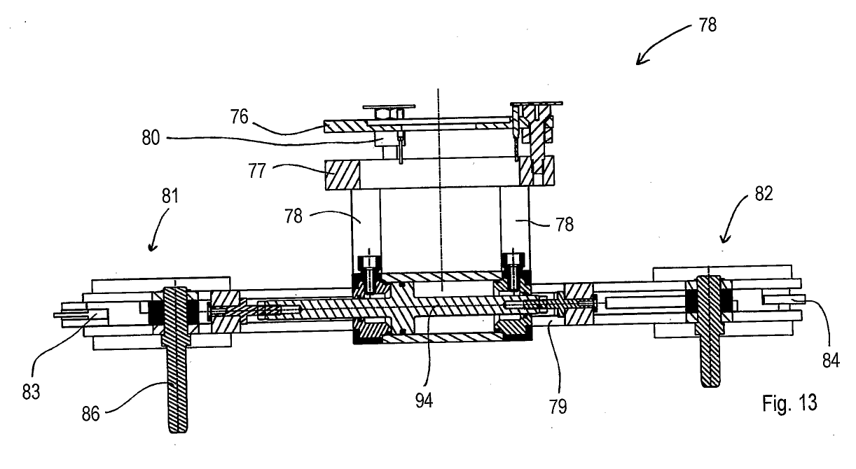

FIG. 13 is a longitudinal section of the caulking device in FIG. 11.

With reference to FIG. 1, there is illustrated a system 1 used in the door and window industry for machining and assembling casings 2 of frames (FIG. 10) such as, for example, windows, french windows, doors, shutters, and the like.

The system 1 comprises a loading magazine 3 arranged for loading onto the caulking machine 1 section bars 4 (FIG. 5) that have not yet been machined, for example extruded aluminium sections, arranged, once they have been finished, for being assembled to make a casing 2.

The loading magazine 3 is provided with gripping means, which are not shown, which are arranged for firmly gripping the section bars 4 and for conveying the latter to a cutting/milling centre 5 positioned downstream of the loading magazine 3.

The cutting/milling centre 5 is arranged for cutting and milling the unworked section bars 4 firmly gripped by the aforesaid gripping means.

The system 1 further comprises an unloading magazine 6 positioned downstream of the cutting/milling centre 5 and arranged for receiving the semifinished section bars 4 from the latter.

The unloading magazine 6 is provided with detecting means, that is not shown, arranged for detecting the presence of reject section bars 4.

If the detecting means detects the presence of reject section bars 4 the latter are conveyed by a conveyor belt 7 to a removal zone 8 where they are removed by an operator 11.

The system 1 further comprises a handling station 9, facing the unloading magazine 6, and provided with a first anthropomorphic robot 10, for example an anthropomorphic robot with six controlled axes.

The first robot 10 is arranged for removing the semifinished section bars 4 from the unloading magazine 6, positioning the semifinished section bars 4 in a cleaning station 12 that eliminates possible chips present at the ends of the semifinished section bars 4 that could compromise successive assembly thereof, and for loading, without resting, the section bars 4 that have just been finished by the cleaning station 12, in a drawer, which is not shown, of a buffer magazine 13.

The buffer magazine 13 is provided with a plurality of drawers, arranged for each containing a group of section bars 4 intended for making a determined casing 2.

In an embodiment of the invention, the buffer magazine 13 comprises thirty-six drawers.

The buffer magazine 13 comprises a loading side 15 where the section bars 4 removed from the unloading magazine 6 are positioned by the first robot 10 and an unloading side 16, from which the section bars 4 are unloaded, as will be disclosed below.

For example, in use, a pair of full drawers are positioned on the unloading side 16, each comprising a casing 2 to be assembled.

The system 1 further comprises a supervisory computer 14 arranged for controlling the buffer magazine 13.

In particular, the supervisory computer 14 assigns a first free drawer of the buffer magazine 13 to a group of section bars 4 coming from the unloading magazine 6 and arranged for making a determinate casing 2.

The system 1 further comprises a machine tool 200 arranged for assembling and machining the section bars 4 for making the casings 2.

The machine tool 200 comprises a first manipulating unit 17, provided with a second anthropomorphic robot 18, between the handling station 9 and the first manipulating unit 17 there being interposed the buffer magazine 13.

The second robot 18 is provided with gripping means arranged for removing the section bars 4 contained in a full drawer positioned on the unloading side 16 of the buffer magazine 13, positioning them one at a time on an assembly unit 19 and subsequently arranged for inserting into the latter corner joints 38 (FIG. 6) removed from a corner joints magazine 39.

It should be noted that the drawers that have just been emptied are transferred from the unloading side 16 to the loading side 15 of the buffer magazine 13 to be filled with further section bars 4.

Returning to the assembly unit 19, shown schematically in FIGS. 2 and 3, this is arranged for supporting, centering and assembling the section bars 4.

The assembly unit 19, which is rotatable around a rotation axis Z, comprises a supporting frame body 20.

The supporting frame body 20 comprises a first frame 21 and a second frame 22 that are opposite one another, each arranged for supporting and assembling the section bars 4 and supported by a support 201 mounted on a motor 202.

Subsequently there is disclosed in detail only the first frame 21, inasmuch as the second frame 22 is substantially and structurally similar to the latter.

The first frame 21, shown in FIG. 2, comprises grasping means 40 arranged for grasping and moving the section bars 4.

The grasping means 40 comprises first grasping means 51, second grasping means 52, third grasping means 53 and fourth grasping means 54 arranged for each grasping a respective section bar 4.

The first grasping means 51, the second grasping means 52, the third grasping means 53 and the fourth grasping means 54 are respectively positioned along a first side 41, a second side 42, a third side 43 and a fourth side 44 of the first frame 21.

The first frame 21 further comprises a centering device arranged for centering the section bars 4 on the first frame 21 to give precise references to the second robot 18.

The centering device comprises first centering means 46, second centering means, third centering means and fourth centering means, that are not shown, positioned substantially parallel to the first side 41, to the second side 42, to the third side 43 and to the fourth side 44 and substantially opposite respectively the first grasping means 51, the second grasping means 52, the third grasping means 53 and the fourth grasping means 54.

Only the first centering means 46 is disclosed below inasmuch as the second centering means, the third centering means and the fourth centering means are substantially, structurally and functionally similar.

The first centering means 46, shown schematically in FIG. 4, is arranged for defining a preset centering position W on the first work plane 21 for a first section bar 36.

The first centering means 46 is provided with compensating means 110 comprising a first abutment 27 and a second abutment 28 that are movable towards and away from one another through an forward and backward stroke of a preset length, along an operating direction X.

The first abutment 27, being substantially L-shaped, comprises a first active surface 29 arranged, in use, for contacting a first end 31 of the first section bar 36.

The second abutment 28 comprises a base element 34 connected by elastic means 35 to a compensating element 66, arranged for compensating possible dimensional variations of the section bars 4.

The compensating element 36 is in fact supported for sliding by guide means 32, associated with the base element 34, and the compensating element 36 is movable along the operating direction X with respect to the base element 34.

The compensating element 66 comprises a second active surface 30, facing the first active surface 29 and arranged for contacting a second end 33 of the section bar 4 opposite the first end 31.

The first active surface 29 and the second active surface 30 cooperate to define the centering position W for the first section bar 36.

The operation of the first centering means 46 is disclosed below.

Initially, the second robot 18 removes from the buffer magazine 13 a first section bar 36 and a second section bar 56 and delivers the first section bar 36 and the second section bar 56 respectively to the first grasping means 51 and to the second grasping means 52, which grasp the first section bar 36 and the second section bar 56, without locking them.

It should be noted that once the first section bar 36 and the second section bar 56 have been grasped by the first grasping means 51 and by the second grasping means 52, both the first grasping means 51 and the second grasping means 52 proceed substantially simultaneously to centre the respective section bars; the operation of the first centering means 46 only is disclosed below inasmuch as the second centering means operates in a substantially similar manner. After the first section bar 36 has been grasped by the first grasping means 51, the first centering means 46 is driven, for example by an actuating means, to position the first abutment 27 and the second abutment 28 in the preset centering position W.

Still subsequently, the first grasping means 51 takes the first end 31 and the second end 33 of the first section bar 36 against the first centering means 46, which positions the first section bar 36 in the desired centering position W with respect to the first frame 21.

Possible dimensional variations of the first section bar 36, due, for example, to thermal dilation/contraction, imprecise machining or the like that would compromise correct centering of the first section bar 36 on the first frame 21 are compensated by the compensating element 66, that is movable towards/away from the base element 34 along the operating direction X.

Once centred, the first section bar 36 is locked firmly by the first grasping means 51 and the first centering means 46 is positioned in a rest position.

Subsequently, the second robot 18 inserts into suitable housings, which are not shown, obtained respectively in the first end 31 and in the second end 33 of the first section bar 36 a pair of corners joints 38 removed from the corner joints 39 magazine and into further housings that are not shown, obtained respectively in a third end 57 and into a fourth end 58 of the second section bar 56 a further pair of corner joints 38 (FIG. 6).

It should be noted that in the case of section bars provided with thermal break, inserting four corners for each section bar can be provided.

Subsequently, a third section bar 59 and a fourth section bar 60 that are opposite one another and interposed between the first section bar 36 and the second section bar 56 are loaded and centred on the first frame 21 in a similar manner to what has been disclosed above.

Still subsequently, the third grasping means 53 and the fourth grasping means 54, and with the third grasping means 53 and the fourth grasping means 54 the third section bar 59 and the fourth section bar 60 are moved substantially parallel to the axis Z towards the second section bar 56 by the first grasping means 51, and then by the first section bar 36, moved in the direction indicated by the first arrow F1.

In this way the first section bar 36, the second section bar 56, the third section bar 59 and the fourth section bar 60 are compacted until the first section bar 36, the second section bar 56, the third section bar 59 and the fourth section bar 60 form the casing 2.

It should be noted that the information on the number and type of corner joints to be used is supplied to the second robot 18 by the supervisory computer 14.

After the casing 2 has been compacted, the assembly unit 19 rotates around the rotation axis Z thereof by about 180°, in such a way that, on the one side, the first frame 21 faces a second manipulating unit 67 arranged for subjecting the section bars 4 to a desired machining, such as, for example, caulking, gluing, broaching, drilling, screwing, and on the other side, the second work plane 22 faces the second robot 18.

In this way, whilst the second manipulating unit 67 performs the aforesaid machinings, the first manipulating unit 17, by the second robot 18, removes further section bars 4 contained in a further full drawer of the buffer magazine 13 positioned on the unloading side 16, positions the further section bars 4 one at a time on the second work plane 22, and assembles the further section bars 4 in a similar manner to what has been disclosed previously.

The second manipulating unit 67 comprises a third anthropomorphic robot 68, provided with a caulking and gluing device 78, shown in FIGS. 11 to 13, arranged for caulking and gluing the first corner 71, the second corner 72, the third corner 73 and the fourth corner 74 of the casing 2.

The caulking and gluing device 78 comprises a fixing flange 76, having a substantially circular shape, arranged for being fixed through threaded connecting means to the third robot 68.

With the flange 76 there is associated a connection 77 arranged for supporting by means of a plurality of tubular elements 78 a framework 79, between the connection 77 and the flange 76 there being interposed elastic elements 80.

The framework 79 is arranged for supporting respectively at a first end portion 81 and at a second end portion 82 a first caulking clamp 83 and a second caulking clamp 84 arranged for caulking respectively section bars devoid of or provided with thermal break.

Only the first clamp 83 is disclosed below, inasmuch as the second clamp 84 is substantially and functionally similar to the latter.

The first clamp 83 comprises a pair of jaws 85 that are rotatable around pin means 86.

The pin means 86 is associated with and projects from the framework 79 and is arranged, in use, for removably engaging seat means 87 obtained in the supporting frame body 20 of the assembly unit 19.

In this way, in use, the caulking forces generated by the first clamp 83 are discharged onto the supporting frame body 20 and not onto the third robot 68.

Each jaw 85 further comprises cam means 90 each arranged for engaging a roller 91.

The roller 91 is moved by a presser 92 driven by a piston 94 and slidable along a guide of the framework 79.

In this way, by driving the presser 92 the roller 91 is forced to slide along the cam means 90, closing and/or opening the jaws 85.

Each of the jaws 85 further supports a caulking cutter 96 at an end thereof.

The caulking and gluing device 78 further comprises a nozzle 97 arranged for injecting into holes, which are not shown, obtained in the section bars 4 a desired quantity of glue, removed from a doser that is not shown and arranged for fixing the section bars 4 in a stable manner.

In an embodiment of the invention, which is not shown, the third anthropomorphic robot 68 is provided with a drilling unit arranged for drilling said section bars 4.

In a further embodiment of the invention, which is not shown, the third anthropomorphic robot 68 is provided with a broaching machine arranged for inserting broaches into the section bars 4.

In a still further embodiment of the invention, which is not shown, the third anthropomorphic robot 68 is provided with a screwing head.

In another embodiment of the invention, which is not shown, also the second robot 18 can be provided with a caulking and gluing device, with a drilling unit, with a broaching machine, and with a screwing head.

Once the casing 2 has been fixed stably, the third robot 68 rotates and drives a safety switch that stops the caulking machine 1 and opens an access door 100.

During opening of the access door 100 a printing device 101 prints a recognition label on the casing 2 that has just been made.

Subsequently, the casing 2 that has just been made can be removed from the first frame 21.

Once the casing 2 has been unloaded, the operator 11 presses an end-of-unloading switch that closes the access door 100 and gives a signal to the assembly unit 19 by the supervisory computer 14 to rotate the supporting frame body 20 to enable the second manipulating unit 67 to fix the further casing 2 that was previously assembled by the second frame 22 and by the second robot 18.

Upstream of the first manipulating unit 17 there can also be provided a spreading unit arranged for spreading a seal on the end portions of the section bars 4.

It should be noted that owing to the invention it is possible to make a highly automated machine tool that enables the metal section bars 2 to be centred, assembled and caulked automatically.

Lastly, it should be noted that owing to the aforesaid invention it is possible to make a particularly versatile machine tool inasmuch as depending on the equipment mounted on the second manipulating unit 67 it is possible to subject the section bars 4 to a plurality of machinings such as caulking, gluing, drilling, broaching and screwing.

1-59. (canceled)

60. A machine tool for assembling metal section bars of casings, comprising an assembly unit arranged for supporting and assembling said metal section bars, said assembly unit being movable between a first operating position in which said metal section bars are positionable on said assembly unit and a second operating position in which said metal section bars can be subjected to a desired machining, wherein said assembly unit is rotatable around a rotation axis between said first operating position and said second operating position, said assembly unit comprising a supporting frame arrangement arranged for supporting said metal section bars and said casings, said supporting frame arrangement comprising a first frame and a second frame positioned on sides opposite with respect to said rotation axis.

61. A machine according to claim 60, wherein at said first operating position there is provided a first manipulating unit.

62. A machine according to claim 60, wherein at said second operating position there is provided a second manipulating unit.

63. A machine according to claim 62, wherein at said first operating position there is provided a first manipulating unit and said assembly unit is positioned between said first manipulating unit and said second manipulating unit.

64. A machine according to claim 60, wherein said supporting frame arrangement comprises a grasping arrangement arranged for grasping and moving said section bars to assemble said casings.

65. A machine according to claim 64, wherein at least one grasping arrangement is provided between said first frame and said second frame.

66. A machine according to claim 64, wherein both said first frame and said second frame comprise said grasping arrangement.

67. A machine according to claim 64, wherein said grasping arrangement is provided on a first side, on a second side, on a third side, and on a fourth side of said supporting frame arrangement.

68. A machine according to claim 60, and further comprising a centering arrangement associated with said supporting frame arrangement and arranged for centering said metal section bars on said supporting frame arrangement.

69. A machine according to claim 68, wherein said centering arrangement comprises a compensating device arranged for compensating possible dimensional variations of said metal section bars.

70. A machine according to claim 69, wherein said compensating device comprises a first abutting arrangement and a second abutting arrangement that are movable towards/away from one another along an operating direction between a work position and a rest position in which said first abutting arrangement and said second abutting arrangement are respectively brought into contact with and moved away from a first end and a second end of said section bar.

71. A machine according to claim 70, wherein said second abutting arrangement comprises a supporting element arranged for supporting a compensating element.

72. A machine according to claim 71, wherein said compensating element is movable along said operating direction with respect to said supporting element.

73. A machine according to claim 71, wherein said compensating element is provided with an active surface arranged for contacting said second end.

74. A machine according to claim 71, wherein said compensating element is associated with said supporting element by an elastic element.

75. A machine according to claim 62, wherein at said first operating position there is provided a first manipulating unit and said first manipulating unit and/or said second manipulating unit comprise an anthropomorphic robot.

76. A machine according to claim 75, wherein said compensating device comprises a first abutting arrangement and a second abutting arrangement that are movable towards/away from one another along an operating direction between a work position and a rest position in which said first abutting arrangement and said second abutting arrangement are respectively brought into contact with and moved away from a first end and a second end of said section bar and in said first operating position said anthropomorphic robot comprises gripping elements arranged for inserting into said first end and into said second end a connecting arrangement arranged for connecting said section bars.

77. A machine according to claim 75, wherein in said second operating position said anthropomorphic robot is provided with a drilling unit arranged for drilling said section bars.

78. A machine according to claim 75, wherein in said second operating position said anthropomorphic robot is provided with a broaching machine arranged for inserting broaches into said section bars.

79. A machine according to claim 75, wherein in said second operating position said anthropomorphic robot is provided with a screwing head.

80. A machine according to claim 75, wherein in said second operating position said anthropomorphic robot is provided with a caulking clamp arrangement arranged for caulking and gluing said section bars.

81. A machine according to claim 80, and further comprising a coupling arrangement arranged for removably coupling said clamp arrangement with said supporting frame arrangement.

82. A machine according to claim 81, wherein said coupling arrangement comprises a pin.

83. A machine according to claim 82, wherein said pin is associated with said clamp arrangement.

84. A machine according to claim 82, wherein said pin projects from a framework of said clamp arrangement.

85. A machine according to claim 82, wherein said clamp arrangement comprises a jaw having an end portion which is rotatably associated with said pin.

86. A machine according to claim 82, wherein said coupling arrangement comprises a seat.

87. A machine according to claim 86, wherein said seat is obtained in said supporting frame arrangement.

88. A machine according claim 60, and further comprising a cutting and milling center arranged for cutting and milling said section bars.

89. A machine according to claim 87, and further comprising a loading magazine arranged for moving said section bars to said cutting and milling centre.

90. A machine according to claim 88, and further comprising an unloading magazine arranged for receiving said section bars from said cutting and milling center.

91. A machine according claim 60, and further comprising a finishing device arranged for removing from said section bars possible machining chips.

92. A machine according to claim 91, and further comprising an unloading magazine arranged for receiving said section bars from said cutting and milling center and comprising a handling device arranged for transferring said section bars from said unloading magazine to said finishing device.

93. A machine according to claim 91, and comprising a magazine arranged for receiving said section bars from said finishing device.
